(19) United States
(12) Patent Application Publication
(10) Pub. No.: US 2026/0170766 A1
(43) Pub. Date: Jun. 18, 2026

(54) SYSTEMS AND COMPUTER-IMPLEMENTED METHODS FOR GRAPHICALLY AND SIMULTANEOUSLY REPRESENTING INTEGRATED DATA, INFORMATION, AND KNOWLEDGE ON A DISPLAY

(71) Applicant: UNIVERSITY OF MARYLAND, BALTIMORE COUNTY, BALTIMORE, MD (US)

(72) Inventors: Lee Boot, Baltimore, MD (US); Tristan King, White Salmon, WA (US); Anita Komlodi, Baltimore, MD (US); James Zuber, Abingdon, MD (US); Vyacheslav Lyubchich, Great Mills, MD (US); June Young, Baltimore, MD (US); John Maxwell Boot, Chicago, IL (US)

(21) Appl. No.: 19/417,540

(22) Filed: Dec. 12, 2025

Related U.S. Application Data
(60) Provisional application No. 63/730,988, filed on Dec. 12, 2024.
(60) Provisional application No. 63/830,800, filed on Jun. 26, 2025.

(51) Int. Cl. G06T 19/00; G06N 3/0475; G06T 15/00

(52) U.S. Cl. CPC G06T 19/00; G06N 3/0475; G06T 15/00; G06T 2200/24; G06T 2219/004

(57) ABSTRACT

Systems and computer-implemented methods for representing data, information, and knowledge graphically for the purpose of systems thinking through integrated visual and computational modeling using a display are disclosed. According to an aspect, a computer-implemented method includes receiving a dataset comprising data items from which users create data visualization assets and associate them with a system via visual analysis. The method includes providing visual encodings for a three-dimensional representation of the system. The visual encodings include nodes and node edges. The method includes mapping the data items and/or attributes to the nodes and the node edges. The method includes rendering the three-dimensional representation that includes graphical representations of nodes connected by the one or more node edges that are mapped by the data items and/or the attributes of the system. The method includes updating the mappings and/or the graphical representations to generate an updated three-dimensional representation of the system.

### CROSS-REFERENCE TO RELATED APPLICATIONS

This application claims priority to U.S. Provisional Patent Application No. 63/730,988, filed Dec. 12, 2024, and titled IMMERSIVE VISUALIZATION ENVIRONMENT FOR INTEGRATING DATA INTO SYSTEMS MODELING, and to U.S. Provisional Patent Application No. 63/830,800, filed Jun. 26, 2025, and titled IMMERSIVE VISUALIZATION ENVIRONMENT FOR INTEGRATING CONCEPTUAL AND COMPUTATION MODELING OF COMPLEX ADAPTIVE SYSTEMS; the contents of which are incorporated herein by reference in their entireties.

### BACKGROUND

Since the early days of computing, data visualization on computer displays has evolved from text-based representations to sophisticated, interactive graphics for visually conveying complex data and information. Early examples of visual depictions of data included bar charts, scatter plots, and pie charts. Later, data was represented by dynamic, browser-based visualizations using vector graphics (SVG) and raster images. Chart types, such as line, bar, area, and radar, have been used to represent time series, comparisons, distributions, and correlations. In addition, color, size, and position emerged as primary encoding channels. More recently, data visualizations have blended static and dynamic elements across two-dimensional (2D) and three-dimensional (3D) spaces. These more recent techniques have been enhanced by animation, layering, and small multiples to show change over time or across categories.

An important technique for concept visualization is referred to as “systems notation”. Systems notation generates visuals that reveal the relationships, connections, and interactions between the components of a larger system, rather than just displaying isolated data points. Further, systems notation involves moving beyond traditional analysis to a holistic approach, using tools such as causal loop diagrams and system maps to uncover root causes and model a dynamic, complex system.

There have been significant advances for presenting data on computer displays in a meaningful way to viewers. However, there is a continuing need for improved techniques to abstract, visualize, analyze, and interact with models of complex systems.

### SUMMARY OF THE DISCLOSURE

The presently disclosed subject matter relates to systems and computer-implemented methods for representing data, information, and knowledge graphically on a display. According to an aspect, a computer-implemented method includes receiving a dataset comprising data items associated with a system. Further, the computer-implemented method includes determining one or more attributes of the system. The computer-implemented method may also include providing visual encodings for a three-dimensional representation of the system. The visual encodings include nodes and one or more node edges. Further, the computer-implemented method includes mapping one or more of the data items and/or the attribute(s) of the system to one of the nodes and node edges of the visual encodings. The computer-implemented method also includes rendering, on the display, the three-dimensional representation of the system that includes graphical representations of nodes connected by the one or more node edges that are mapped by the data item(s) and/or the attribute(s) of the system. Further, the computer-implemented method includes receiving, via a user interface, user interaction with the rendered three-dimensional representation of the system. The computer-implemented method also includes updating the mappings and/or the graphical representations to generate an updated three-dimensional representation of the system in response to the user interaction.

According to another aspect, a system includes a user interface and a display. The system also includes a system visualization manager comprising one or more processors and memory. The system visualization manager is configured to receive a dataset comprising data items each associated with a system. The system visualization manager is also configured to determine one or more attributes of the system. Further, the system visualization manager is configured to provide visual encodings for a three-dimensional representation of the system. The visual encodings include spheres to represent nodes and one or more connection forms to represent node edges. The system visualization manager is also configured to map one or more of the data visualization items and/or one or more attribute of the system to one of the nodes and the node edges of the plurality of visual encodings. Further, the system visualization manager is configured to control the display to render the three-dimensional representation of the system that includes graphical representations of nodes connected by the node edge(s) that are mapped by the data item(s) and/or attribute(s) of the system. The system visualization manager is also configured to receive, via the user interface, user interaction with the rendered three-dimensional representation of the system. Further, the system visualization manager is also configured to update the mapping(s) and/or the graphical representations to generate an updated three-dimensional representation of the system in response to the user interaction.

According to another aspect, system computation can be embedded in the system visualization manager. In an example, computational modeling affects visualization of nodes (represented by the sizes of spheres) and the directions and weights of edges (represented by connection forms). These can be constantly calculating their effect on one another across the system visualization. This allows one to see the impact of all the relationships and to interactively pose “what if” scenarios by changing magnitudes or weights. Further, these separate aspects (systems notation; data visualization; computational modeling full and fluid integration) can be fully integrated.

### BRIEF DESCRIPTION OF DRAWINGS

Having thus described the presently disclosed subject matter in general terms, reference will now be made to the accompanying Drawings, which are not necessarily drawn to scale, and wherein:

FIG. 1 is a block diagram of a system for representing data, information, and knowledge graphically on a display in accordance with embodiments of the present disclosure;

FIG. 2 is a flow diagram of a computer-implemented method for representing data, information, and knowledge graphically on a display in accordance with embodiments of the present disclosure;

FIG. 3 is a diagram of a 3D representation of a system in accordance with embodiments of the present disclosure;

FIG. 4 is a diagram of another 3D representation of a system in accordance with embodiments of the present disclosure;

FIG. 5 is a diagram of another 3D representation of a system in accordance with embodiments of the present disclosure;

FIG. 6 shows a screen display of an immersive 3D environment for integrating data into systems modeling in accordance with embodiments of the present disclosure;

FIG. 7 illustrates a diagram of a constructed example of systems thinking notation;

FIG. 8 a top-down hierarchical model that visualizes the flow of magnitudes and weights in a system model; and

FIG. 9 depicts tables showing the coefficient matrix magnitude vector and the resultant magnitudes of the model visualized in FIG. 8.

### DETAILED DESCRIPTION OF THE DISCLOSURE

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Unless otherwise defined, all technical terms used herein have the same meaning as commonly understood by one of ordinary skill in the art to which this disclosure belongs.

In accordance with embodiments, the present disclosure describes systems and computer-implemented methods for representing data, information, and knowledge graphically on a display. In examples, the present disclosure provides a computer application that utilizes an immersive virtual environment that integrates 3D conceptual modeling based on systems thinking and computation modeling to both visualize and calculate the dynamics of complex adaptive systems (CAS). In embodiments, systems and computer-implemented methods disclosed herein can be utilized for abstract notation for systems thinking. In other embodiments, systems and computer-implemented methods disclosed herein can be utilized for business intelligence, decision support, information design, visualization, computational modeling, and data science.

In embodiments, systems and computer-implemented methods are provided to abstract, visualize, analyze, and interact with models of complex systems. Visually modeling complex systems using abstract systems thinking notation can be used by systems and methods disclosed herein to abstract, visualize, and analyze systemic problems with large, often overwhelming numbers of input factors that influence one another in various ways and to various degrees. Systems and methods disclosed herein can provide organizations that work with complex systemic challenges with the opportunity to increase the depth, breadth, and speed of their work to catalyze a qualitative improvement in both the perception and comprehension of complex systems and their dynamics.

As used herein, the term “memory” is generally a storage device of a computing device. Examples include, but are not limited to, read-only memory (ROM) and random access memory (RAM).

As referred to herein, a “complex system” can refer to a system having numerous interconnected components or agents that interact in non-linear, dynamic ways, producing emergent behaviors, patterns, or outcomes that cannot be fully predicted or explained by analyzing the individual parts in isolation. Components, attributes, or data items (e.g., variables, entities, or data points) of the system can influence each other through networks of relationships, which can be modeled via graphs or correlation matrices. Small changes in inputs can lead to disproportionately large or unexpected outputs (e.g., tipping points in time-series data). Higher-level properties or behaviors arise from lower-level interactions, such as collective patterns in big data (e.g., market crashes from individual trades or flocking in social network data). Positive (amplifying) and negative (stabilizing) loops drive system evolution, detectable through techniques such as Granger causality or loop analysis in datasets.

Complex systems and other systems, to which systems and methods disclosed herein may be applied, can have multiple, interrelated factors from which circumstances and consequent challenges and opportunities emerge. The complexity and intricate dynamics of such systems, often referred to as “wicked” problems, continually frustrate government and non-governmental organizations. Within the public sector and society, they drain public resources, reduce well-being, and both risk and cost lives. For the private sector, there is opportunity cost when large and complex operations cannot be optimized. Few organizations have the tools to analyze and successfully work with such systems. This is not only because the sheer number and types of input factors overwhelms established tools and established problem-solving practices, but also because of synergistic outcomes (positive and negative) that emerge from the intricate interplay among disparate factors are overly cumbersome to analyze with established tools and practices. In some manner, all or many of the factors in such systems mutually interact to various degrees and the complexity of synergistic effects exponentially multiples-becoming ever more nuanced as the influence of each factor is added to the total calculation.

The reductive nature of the scientific method as it is commonly interpreted and used, creates a positive bias toward factors for which quantitative data is affordable and available. There is a lack of tools and practices for integrating computation of quantitative inputs with the subjective estimations about qualitative inputs. Such integration is necessary because, though poorly understood and expensive to measure, even seemingly ethereal and ephemeral factors, particularly those involving human attitudes, beliefs, intentions and behaviors, can determine outcomes as easily as can those factors that are supported by reliable quantitative measured. Examples include, but are not limited to, public health, economic development, income insufficiency and poverty, educational achievement, global conflict, and operations of large organizations.

In accordance with embodiments of the present disclosure, generative artificial intelligence (AI) techniques can support systems and methods disclosed herein. AI can increasingly derive useful and specific meaning from a morass of disparate factors, however they are represented, that typically make up complex dynamic systems. However, those directly involved in AI development and policymakers alike agree that the ultimate critical challenge that AI presents us with is the necessity of developing human beings' capacity to maintain functional oversight and power over AI. For that to be possible, human beings must ostensibly maximize our own ability to make sense of such overwhelming systems. As disclosed herein, techniques are provided that offer ways to provide this capacity, by improving the tools and practices of systems thinking.

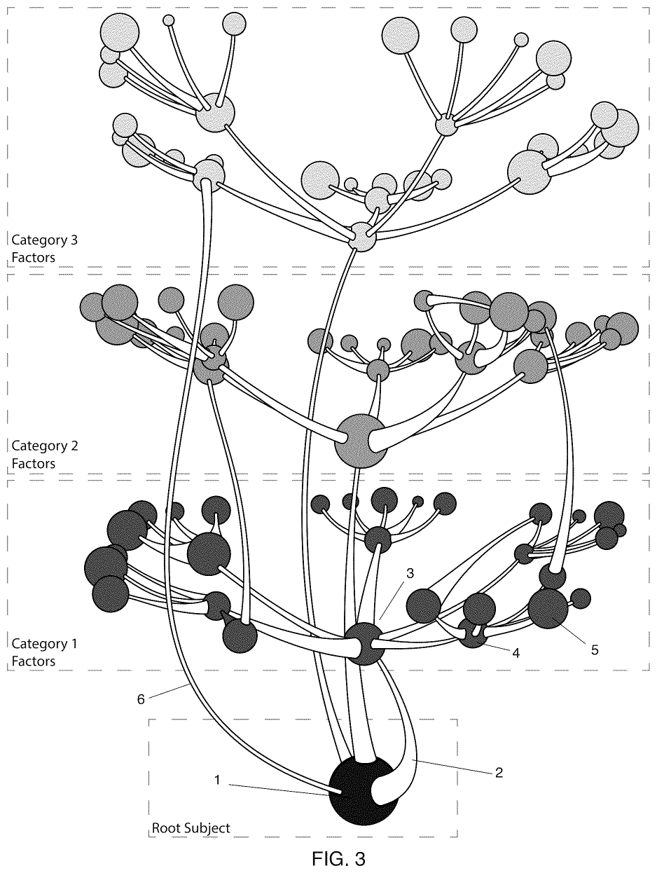

In embodiments, the presently disclosed systems and methods utilize systems thinking notation, which involves the use of a symbolic language for visualizing a network of interrelated factors, the relationships between and among them, and the nature of influence they have upon one another. FIG. 3 depicts an example of systems thinking notation in the embodiment. Systems thinking notation was originally done with paper and pencil. Despite the advent of some digital versions for systems thinking notation, the practice is still not widely used despite its strong potential and unique applicability to the effort to understand and meet the systemic challenges described above. This may be because there is an unfortunate lack of updated digital applications that seek to take advantage of the individual and highly relevant capacities that have been developed in separate and distinct hardware and software applications. These applications offer a promising array of currently available digital applications that are relevant to the development of a fully functional immersive analytics environment, but which are not currently integrated or optimized for that purpose. Computing devices can provide graphic diagramming tools and computation functionalities for systems thinking notation. For example, such computing devices can assist with conceptual modeling (also known as mind mapping, concept mapping, graphic organizing, and diagramming). Both 2D and 3D modeling, simulation, and interaction can be implemented by suitably configured computing devices. Computing device tools can provide data visualization and analysis in business intelligence and decision support applications. Further, computing device tools can be used for complex algorithmic and artificially intelligent systems modeling with quantitative data.

With continuing reference to FIG. 3, this figure shows the structure of an embodiment of a typical system model. It is a tiered structure with a vertical armature. The tiers are radial tree structures and that can be understood as distinct both by their relative placement in the overall structure and by color coding. Those two differentiators are meant to be used in combination as perception of 3D visualizations benefits from this kind of “belt and suspenders” approach. The design makes the overall structure comprehensible in ways that traditional systems thinking notation does not but allows for enough asymmetry and irregularity to exist in the structure to accommodate the unique, multifactorial reality of the system being modeled. This structure is an example of biomimicry inspired by plant life.

Systems and methods disclosed herein may be used with suitable displays for presenting graphics. Example displays include, but are not limited to, standard displays, virtual reality (VR) headsets, augmented reality (AR) headsets, and VR/AR (XR) headsets. VR, AR, and XR headsets include displays. VR, AR, and VR/AR headsets can incorporate stereo vision and head tracking, both of which can assist a user with accurately assessing relative positions of object in space as well as their comparative sizes. Additionally, there are continuing advancements to available systems that offer users a 3D, stereoscopic, head-tracking experience on a flat display monitor augmented with devices users do not have to wear on their persons.

In embodiments, systems and methods disclosed herein can be used in a collaborative setting with multiple users. For example, as described in more detail herein, multiple users may utilize their own display for viewing a 3D representation of a system. Each user may interact with a rendered 3D representation of the system. In response to the user interaction, the system or method may update one or more mappings and graphical representation to generate an updated 3D representation of the system for display on the displays of the different users.

In accordance with embodiments, a suitable computational tool may be used for implementing the presently disclosed subject matter. In an example, the 3D visualization software toolset may be used to calculate how the values of nodes influence those of other nodes by way of their edge connections with other “downstream” nodes, and the relative weights of such edge connections to downstream nodes. This calculation system is embedded in the 3D visualization software and does not reside on a server that is external to the software. This is as opposed to the structural equation modeling (SEM) described elsewhere in this disclosure which does reside on an external server. The toolset uses computation to determine the influence of factors in a model of a system. Models produced using the toolset contain nodes and connections between them. Nodes have initial and final magnitudes and connections have weights. Final magnitudes are calculated based on initial magnitudes and the weights of connections.

In embodiments, the computational elements of a computational tool model include nodes and connections as described. A node is a discrete element of a model with a unique identifier and an initial magnitude in the range [−1, 1]. Nodes additionally have a computed final magnitude in the range [−2, 2]. A connection is between two nodes and has a weight in the range [−1, 1]. Connections are directed meaning that a connection from node A to node B is distinct from a connection from node B to node A. Connections are unique, meaning that only one connection from a given node to another given node may exist though nodes may have multiple incoming or outgoing connections. Connections may be reciprocal meaning that, for example, a connection from node A to node B may exist at the same time as a connection from node B to node A. A node may not be connected to itself.

The final magnitude of a node is equal to the sum of the initial magnitudes of all nodes with incoming connections multiplied by the weights of those connections. Additionally, node influences propagate across multiple connected nodes. This means to calculate the final magnitude of a node, all incoming connections must be considered as well as any incoming connections to the source nodes of those connections. As final magnitudes are constrained this computation is guaranteed to converge even if a feedback loop is present. The equation for the final magnitude of node x can be written as

$${mag}_{fx} = {mag}_{0 x} + {\sum }_{i = 0}^{m} {mag}_{0 i} * {\prod }_{j = 0}^{l} {w}_{j} ,$$

where mag₀ refers to the initial magnitude of a node, mag_{f} refers to the final magnitude, m refers to the number of nodes with a connection path to node x, I to the length of the path from node i to node x, and w to the weight of a connection on that path.

In computation, a model in accordance with the present disclosure can be represented by a directed, weighted graph where a node in the model corresponds to a node in the graph and a connection in the model corresponds to an edge between two nodes in the graph. As this tool allows for feedback loops, the graph is not guaranteed to be acyclic and may not be connected. An n by n adjacency matrix is constructed where n is the number of nodes in the model and the value at Aᵢⱼ corresponds to the weight of the connection between the nodes at index i and j of the model.

This adjacency matrix is used to pre-compute a coefficient matrix C for the model. The formula for this coefficient matrix is

$${\sum }_{i = 0}^{c * n} {A}^{i}$$

where n is the number of nodes in the model and c is an adjustable constant used to account for feedback loops. This equation captures the propagation of influences across the model. The coefficient matrix is computed once and reused until a change in the weight of a connection or the deletion of a connection invalidates the previous coefficient matrix.

To compute the final magnitudes, vector M of length n is constructed such that the value of Mᵢ is the initial magnitude of node i. The product of C and M is then added to M to compute the final magnitude of the nodes. The result is the clamped in the range [−2,2] and the magnitudes are assigned to the nodes in model.

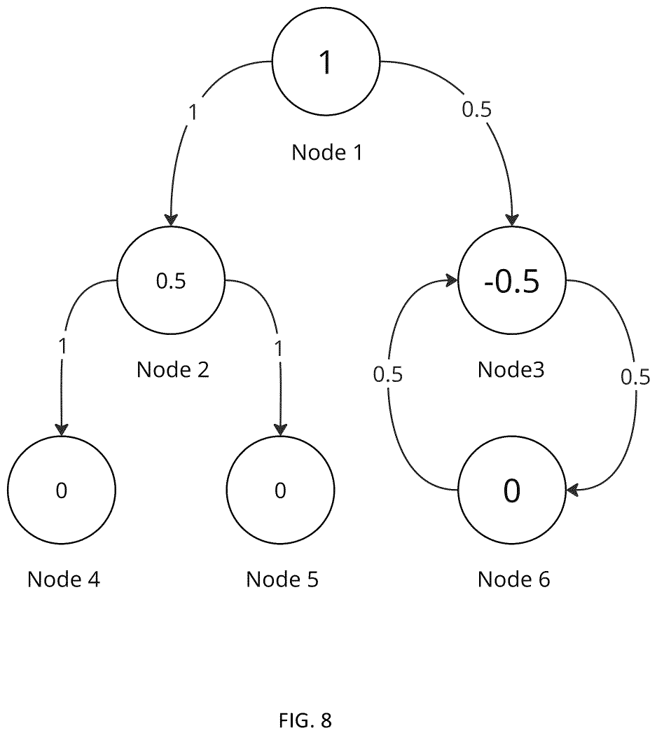

FIG. 8 is a top-down hierarchical model with nodes and edges that includes a feedback loop. It demonstrates values of connection weights and node initial magnitudes.

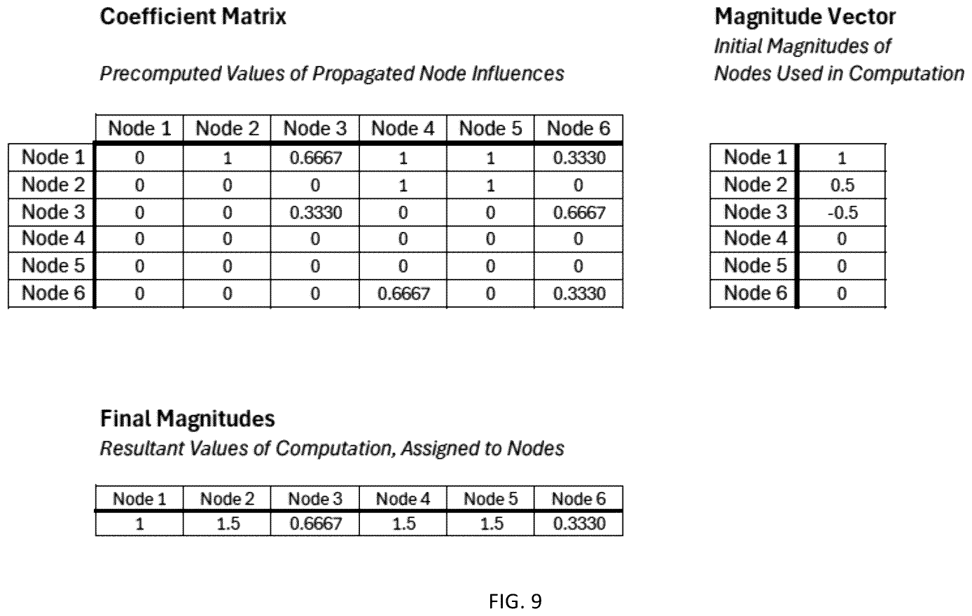

FIG. 9 depicts the table showing the values used in computation. The coefficient matrix contains the pre-computed values that capture the propagated node influences from FIG. 8. This coefficient matrix is reused in future computation until it is invalidated when a connection is modified. The initial magnitudes of nodes are dynamic across distinct computations; computation is triggered when initial magnitudes change. The final magnitudes are the product of the coefficient matrix and magnitude vector.

As referred to herein, the terms “computing device” and “entities” should be broadly construed and should be understood to be interchangeable. They may include any type of computing device, for example, a server, a desktop computer, a laptop computer, a smart phone, a cell phone, a pager, a personal digital assistant (PDA, e.g., with GPRS NIC), a mobile computer with a smartphone client, or the like.

As referred to herein, a user interface is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. A user interface can include an input for allowing users to manipulate a computing device, and can include an output for allowing the computing device to present information and/or data, indicate the effects of the user's manipulation, etc. An example of a user interface on a computing device includes a GUI that allows users to interact with programs or applications in more ways than typing. A GUI typically can offer graphical representations, display objects, and visual indicators, as opposed to text-based interfaces, typed command labels or text navigation to represent information and actions available to a user. For example, a user interface can be a display window or display object, which is selectable by a user of a computing device for interaction with a graphical representation, for example. The display object or the graphical representation can be displayed on a display screen of a computing device and can be selected by and interacted with by a user using the user interface. In an example, the display of the computing device can be a touch screen, which can display the display icon or the graphical representation.

As referred to herein, a dataset is a structured collection of related data. The dataset can be organized in a standardized format, such as tables, arrays, or files (e.g., CSV, JSON, or Excel), designed for retrieval, analysis, and observation. The dataset may be grouped as rows (records or examples) and columns (features or attributes), with each row representing an entity (e.g., a person, product, or event) and each column describing a variable or characteristic associated with those entities. Datasets can encompass different data types, including numerical, categorical, time series, images, text, and/or the like. Data in datasets can be used for tasks or processes such as statistical analysis, machine learning, AI, and business intelligence.

As referred to herein, a data item in a dataset can refer to a single piece of information that represents a value of a property or variable for an object. The data item can be representative of the value at a particular point in time. Further, the data item may be the smallest unit of data stored in a field within a dataset, such as a database, table, or any other structured data collection.

As referred to herein, an attribute of a system can refer to a property, characteristic, or trait that describes, quantifies, or identifies some aspect of the system. Attributes can define the features or qualities that make up the system. As an example, an attribute can be measured quantitatively (e.g., with numbers). In another example, an attribute can be measured qualitatively (e.g., with descriptive terms).

Systems and computer-implemented methods disclosed herein can represent data three-dimensionally via any suitable technique. In an example model, a point cloud model can be employed with discrete points defined by (x, y, z) coordinates in space. Systems and computer-implemented methods disclosed herein can provide visual encodings for displaying a 3D representation of a system. The visual encodings can include nodes and node edges. The system can map data items and attributes of a system to the nodes and nodes edges for rendering a 3D representation of the system on a display. A user can interact with the rendered 3D representation of the system. In response to the interaction, the system can update the mappings and graphical representation to generate an updated 3D representation of the system.

Edges and nodes in 3D visuals can be represented by spatially placed 3D shapes connected by lines, curves, or other forms specifically designed to communicate characteristics of relationships between and among nodes, with visual properties encoding additional data attributes to facilitate understanding of complex relationships. Nodes can be represented as 3D shapes (forms), such as spheres or other objects intended to symbolize categories of content. Each node can be positioned in 3D space using coordinates (e.g., x, y, z), which can be fixed or dynamically computed with layout algorithms or specified externally. Visual attributes such as size, color, opacity, labels, or the like further describe nodes' properties or categories, allowing differentiation or emphasis. Edges can be visualized as lines, cylinders, or curves connecting pairs of nodes. Edges can follow spatial paths between node positions, showing relationships or flows. Curved edges and arrowheads can represent directionality or weights, enhancing clarity. Edge thickness, color, opacity, or other indicia may encode additional information, such as strength or type of connection. 3D graph visualization frameworks can support interactive rotation, zoom, and exploration of nodes and edges, providing an effective way for users to analyze complex networks in 3D. Suitable tools may be utilized for allowing dynamic updates of node positions, flexible rendering of different node and edge styles, and filtering for better focus.

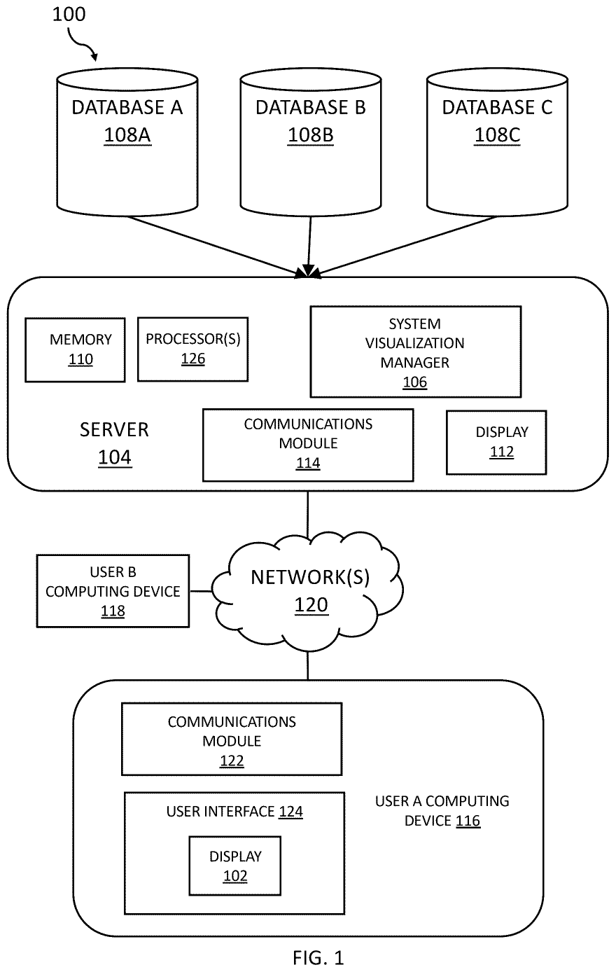

FIG. 1 illustrates a block diagram of a system 100 for representing data, information, and knowledge graphically on a display 102 in accordance with embodiments of the present disclosure. It is noted that the system 100 of FIG. 1 is an exemplary system of implementing functionalities described herein, but it should be appreciated that the functionalities may be implemented by any other suitable system. Referring to FIG. 1, a server (or other computing device) 104 can be configured to implement a system visualization manager 106 having functionalities as disclosed herein. The server 104 may include or otherwise have access to databases A, B, and C, which are indicated by reference numerals 108A, 108B, and 108C, respectively. As described in further detail herein, the system visualization manager 106 can access a dataset stored in one or more of the databases A-C 108-108C. The dataset can include data items that are each associated with a system, such as a complex system.

Further, the system visualization manager 106 can determine one or more attributes of the system. For example, the system visualization manager 106 can determine an attribute of a complex system. The attributes can be properties, characteristics, and/or traits that describe, quantify, or identify aspects of the system.

The system visualization manager 106 can provide visual encodings for a 3D representation of the system. The visual encodings can include nodes and one or more node edges. Further, the system visualization manager 106 can map the data items and/or the attributes of the system to the nodes and the node edges of the visual encodings. The system visualization manager 106 can store the data needed for rendering the 3D representation in memory 110.

The system visualization manager 106 can render, on a display, the 3D representation of the system that includes graphical representations of nodes connected by the one or more node edges that are mapped by the at least one of the data items and/or the attribute(s) of the system. For example, the server 104 can include a display 112 for displaying the 3D representation of the system. Further, the server 104 can include a communications module 114 configured to communicate the data of the 3D representation of the system to a computing device 116 of User A and/or to a computing device 118 of User B via one or more networks 120. As an example, the computing device 116 of User A can include a communication module 122 for receiving the communicated data of the 3D representation. The computing device 116 of User A can subsequently display 3D representation of the system via the display 102.

The system visualization manager 106 can receive, via a user interface, user interaction with the rendered 3D representation of the system. For example, the computing device 116 of User A can include a user interface 124. Data of the user interaction can be communicated to the server. In response to receive of the user interaction data, the system visualization manager 106 can update the mappings and/or the graphical representations to generate an updated 3D representation of the system in response to the user interaction. The display 102 of the computing device 116 can display the updated 3D representation of the system.

Similar to computing device 116, User B of computing device 118 can interact with a displayed 3D representation of the system. User B can interact with a user interface of the computing device 118 to enter user interaction with the rendered 3D representation of the system. In response to receipt of data of the user interaction and similar to computing device 116, the system visualization manager 106 can update the mappings and/or the graphical representations to generate an updated 3D representation of the system in response to the user interaction. The display of the computing device 118 can display updated 3D representation of the system.

Functionalities of the system visualization manager 106 can be implemented by hardware, software, firmware, or combinations thereof. For example, the system visualization manager 106 can be implemented by one or more processors 126 implementing instructions stored in memory 110.

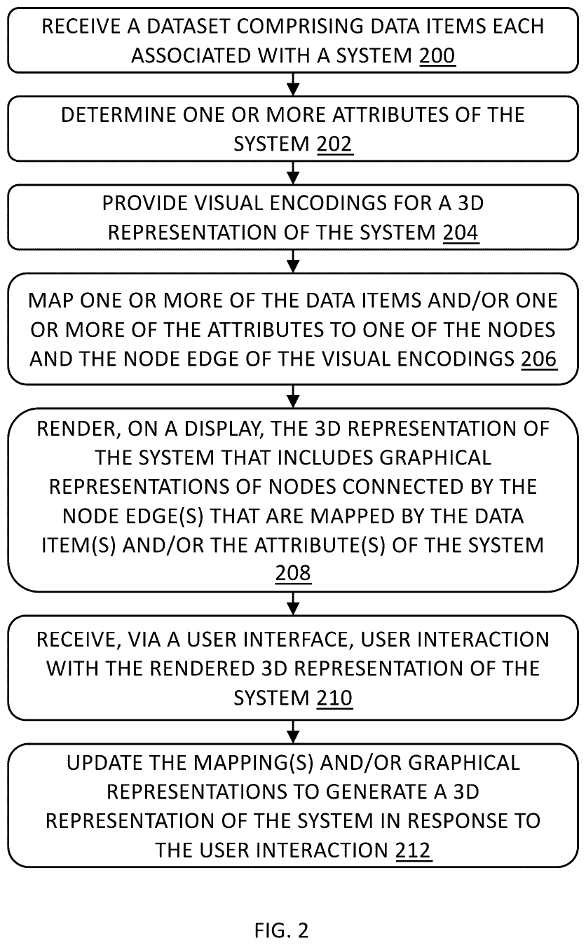

FIG. 2 illustrates a flow diagram of a computer-implemented method for representing data, information, and knowledge graphically on a display in accordance with embodiments of the present disclosure. The computer-implemented method is described as being implemented by computing devices of the system 100 shown in FIG. 1. But it should be recognized by those of skill in the art that the method may be implemented by any suitable system having one or more computing devices.

Referring to FIG. 2, the computer-implemented method includes receiving 200 a dataset comprising data items each associated with a system. For example, the system visualization manager 106 of the server 104 can access a dataset of a complex system stored in one or more of the databases A-C 108-108C. In an example, some data items of the dataset can include categories and/or relationships of other data items in the dataset.

In examples, data can be accessed and imported into the application from external sources. In some instances, user interaction may be required to visualize the data in the 3D space where all modeling and visualization occur. Further, user interaction can be required to analyze the data so that the relevant system can be imagined and constructed through further user interaction. However, automated methods ranging from code that can parse and assign data to a current system model, or construct or augment a system model to accommodate the parsed data can be used. Such engineered methods include the use of machine learning and artificial intelligence.

The computer-implemented method of FIG. 2 includes determining 202 one or more attributes of the system. Continuing the aforementioned example, the attributes can be properties, characteristics, and/or traits that describe, quantify, or identify aspects of the complex system.

The computer-implemented method of FIG. 2 includes providing 204 visual encodings for a 3D representation of the system. The visual encodings include nodes and one or more node edges. Continuing the aforementioned example, graphical representations of nodes can be spheres. Also for example, graphical representations of node edges can be linear or substantially linear shapes (e.g., curved lines).

The computer-implemented method of FIG. 2 includes mapping 206 data items and/or attributes of the system to nodes and the node edges of the visual encodings. Continuing the aforementioned example, the system visualization manager 106 can map the data items and/or the attributes of the system to the nodes and the node edges of the visual encodings

The computer-implemented method of FIG. 2 includes rendering 208, on a display, the 3D representation of the system that includes graphical representations of nodes connected by the one or more node edges that are mapped by the at least one of the data items and/or attribute(s) of the system. Continuing the aforementioned example, the 3D representation can be rendered on the display 102 of the computing device 116 of User A. As an example, rendering the 3D representation of the system can include spatially organizing nodes by categories of data items in the dataset. Visualization of nodes and edges may not require association with a data item, but rather enables it. Magnitudes and weights can be assigned without data support, but rather based on, for example, the experience and intuition of a decision maker.

In embodiments, a display can be controlled to display annotations to a displayed 3D representation of a system. For example, annotations can include, but are not limited to, text, images, video, and the like. Such annotations may be considered data and be visualized and associated with relevant nodes if selected by the user.

In embodiments, the system visualization manager 106 can generate one or more navigational marks and/or marks that are interactive by a user for re-rendering the 3D representation of the system. For example, a navigational mark can be used for orienting a viewer with respect to a rendered 3D representation of the system. In examples, users can use keyboard or game controllers to either “fly” anywhere in the 3D space or instantly teleport to any location or item in the 3D space. In addition, a graphical user interface (GUI) may feature buttons that offer instant teleporting to and from nodes and the data visualization assets that the user has associated with them to support them.

With continuing reference to FIG. 2, the computer-implemented method includes receiving 210, via a user interface, user interaction with the rendered 3D representation of the system. Continuing the aforementioned examples, the computing device 116 of User A can receive data for displaying the 3D representation of the complex system. Subsequent to receiving the data, the display 102 of the computing device 116 can be controlled to display the 3D representation of the system. Further, the display 102 can be controlled to display annotations (or visual assets). Further, for example, the display 102 of the computing device 116 can be controlled to display navigational marks or other marks along with the displayed 3D representation of the system.

The computer-implemented method of FIG. 2 includes updating 212 at least one of mappings and/or the graphical representations to generate an updated 3D representation of the system in response to the user interaction. Continuing the aforementioned example, the system visualization manager 106 can update the 3D representation of the system for re-rendering on the display 102 of the computing device 116.

In embodiments, a user can select a subset of a displayed 3D representation of a system for re-rendering the 3D representation of the system. For example, User A of computing device 116 can select a subset of a 3D representation of the system that is displayed on display 102. Based on the selection, the 3D representation can be re-rendered and displayed on the display 102. For example, a user may select a particular displayed node or node edge and the re-rendered 3D representation can focus on the node or node edge. In examples, the system according to embodiments of the present disclosure can control the display to present a fluid navigation to the re-rendered 3D representation of the system.

In embodiments, the system visualization manager 106 can apply generative artificial intelligence (AI) technology to a dataset of a system to generate another dataset for improving human analysis of the dataset of the system. Further, the system visualization manager 106 can re-render a 3D representation of the system based on the generated other dataset. AI can be used to derive useful meaning from large disparate datasets and complex systems, including quantitative and qualitative factors. Disclosed systems can use regression trees and artificial neural networks. Disclosed systems using AI technology can support computational modeling based on quantitative data and allow for the inclusion of qualitative factors. AI technology can be used for integration and weighting of diverse data types in modeling.

In embodiments, the system visualization manager 106 can determine a user input and/or a computer-generated estimate. This user input and/or the computer-generated estimate can be used as an attribute of the system. Within a system model, factors can have attributes such as magnitude and each relationship between them can have weight that represent its relative status. Values can be derived from historical, empirical, or estimated maximum/magnitude values. Computer-generated estimates can include, but are not limited to, statistical modeling, machine learning, and user input, which can be used as attributes of a modeled system. For example, in the case of assessing a population health risk derived from multiple factors, analysts may pull magnitudes and weights directly from quantitative empirical data, external computational projections or estimates, e.g. derived from machine learning using structural equations, from user inputs based on assessing video interviews of community members, and finally from user inputs based on intuitive estimates of experienced public health professionals.

In embodiments, types of data items can include raw qualitative data. A user can use a user interface to associate the raw qualitative data with a node. The system visualization manager 106 can represent a user-estimated magnitude value with a size of an associated node, and/or a weight of influence with a connector that indicates an influence of an upstream node on a downstream node. In an example, a user can include qualitative data as evidence for factors (nodes) in a model. This may include inputs such as, but not limited to, experience-based intuition, narratives, images, or video clips. Such input need not be reduced to numbers before being used. The system can allow a mixed-methods approach where both empirical, quantitative data and subjective, qualitative data can be modeled together, with qualitative factors treated as drivers of influences.

In embodiments, magnitudes can be assigned to nodes. In addition, weights can be assigned to node connectors. The system visualization manager 106 can determine a change to one or more of the magnitudes, and/or a change to one or more of the weights. Further, the system visualization manager 106 can re-render a 3D representation of the system based on the determined change to one or more of the magnitudes, and/or the change to one or more of the weights. In an example, the user can use the user interface for input for changing one or more of the magnitudes, and/or for changing one or more of the weights. The re-rendering happens nearly instantly if the user has turned on computation for the connected node(s) and for the system model as a whole. In this example, the 3D representation of the system can be re-rendered based on this user input. In another example, nodes and node edges can be re-rendered based on the user-input for changing the magnitude(s), and/or for changing the weight(s). Continuing with the population health example, new quantitative data on population behaviors or the aggressiveness of a contagion. Or, having witnessed the situation “on the ground” a public health official might update and estimate of population attitudes or intentions.

In embodiments, each node in a model can represent a system factor. These nodes can have a magnitude attribute. The magnitude can be based on historical, empirical, or estimated values, including user-input or computer-generated estimates, and captures the relative size, strength, or intensity of that factor within the system context. Magnitudes can be adjusted and visualized dynamically, reflecting current data, simulations, or hypothetical scenarios as users interact with the model. Connectors between nodes can be assigned weights that indicate the strength or intensity of the influence from one node (factor) to another. Weights can be positive or negative to indicate whether the influence is augmenting or diminishing the magnitude of the downstream node. These weights can be derived from computational analysis of data, such as mathematical equations, Structural Equation Modeling (SEM), Artificial Intelligence (AI), or estimated and input by users. Node size can reflect an assigned magnitude. Also, a connector width or style can indicate an assigned weight.

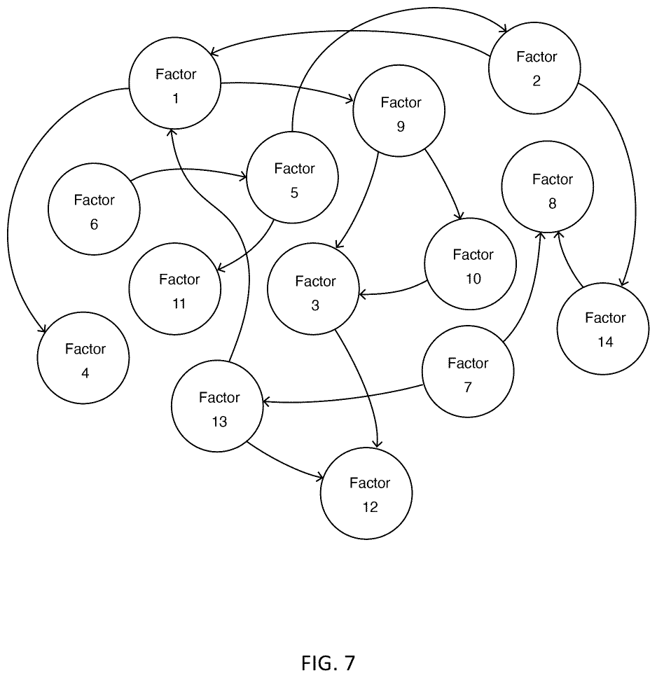

In embodiments, systems and computer-implemented methods disclosed herein integrate and optimize various technological capacities and application features into a single, immersive environment for systems thinking. The environment can be a virtual 3D space or representation that is effectively unlimited in size to visualize very large comprehensive systems models intended, optimally, to include all known or imagined factor in a complex system. Because of this, the overall nature of the system can be modeled and yet also broken down into its components parts and the specific influence they have upon one another. The modeling features can provide conceptual diagramming and systems thinking notation, using spherical nodes that represent the factors that are inputs to a system. A new form of connection symbol to articulate the relationships between and among the factors. Automated processes are built into the software that facilitate the organization and structure of factors so that from first sight they are intelligible. This avoids overloading users of the environment the way the seemingly disorganized visual models created using either traditional systems thinking notation (see FIG. 7) or existing digital conceptual diagramming tools, whether 2D or 3D, often do. Models can also be revealed in levels, starting with a main subject, then primary, secondary, tertiary, sub-factors in a way that synchronizes with users' comprehension.

Though the environment can be used on flat screens and rendered for monoscopic vision, environments disclosed herein is optimized for immersive XR, or stereoscopic flat screen-based systems to improve perception and navigation. Navigating around a model is accomplished through virtual “teleporting” to instantly move around a model. Data that supports factors that make up the model, can be found through interaction with the spherical nodes that represent the factors. Users are instantly transported to quantitative 3D visualizations or qualitative media in the form of text, images, video, or the like.

Models can utilize computation in two ways. One way helps users set initial magnitudes and weights utilizing computation on and external server that is access by the model. The other is by utilizing the computational capacity embedded in the model visualization software that constantly calculates the effects nodes have on one another given their magnitudes and relative weights of the edges that connect them, and instantly visualizes the results. To utilize the first type, users can connect the model to a web-based server component that is a hub, storage center, and computational center for data of all kinds. Magnitudes of factors relative to their historical or predicted minimum, median, and maximum values can be determined from data. Computation can be performed on quantitative data sources using structural equation modeling to find correlations between factors and weight them so that their relative influence upon one another can be established. However, if the data is qualitative, or merely an assumption or idea, users can supply their own estimations of both magnitudes and weights and sharpen those estimates over time by working with the model. Once a model is built spatially so that it is visualized, and its mathematical structure is entered, it becomes a computational system that describes the component factors and relational dynamics of a system. The model visually communicates these dynamics in a way that can be read and understood as a unified whole very quickly compared to other methods of communicating the nature of complex systems. “What if” scenarios can be run by making changes to nodes, connections, magnitudes, or weights and seeing those changes instantly ripple across a model as other magnitudes and weights change automatically in response.

To clarify further, magnitudes and weights can be set either by users or from a server that is part of a system in accordance with the present disclosure. Once set, they can then be changed by the same means. However, when changed, the relative recalculation and subsequent revisualization that effects the rest of the visualized model when the adjusted component is connected, happens entirely within the computing system embedded in the systems modeling feature. Using this division of computing effort, the invention can recalculate and revisualize instantaneously after a change is made, whereas calculations that make changes in the model, when set to be performed on the invention's server or an external server can take any amount of time depending on the specific task and data sources.

The following is a detailed description of, and key rationale for, the integrated components of disclosed embodiment that allow the application to function as a unified systems thinking environment with all its functions taking place in a unified virtual space optimized for 3D environments visualized using stereoscopic, head-tracking systems.

The use of 3D instead of 2D for systems thinking notation/modeling increases the available space exponentially, allowing for a commensurate exponential increase in the number of systemic factors that can be seen simultaneously within a field of view. As a result, complex systemic challenges can be modeled comprehensively. More than any other single capacity of the disclosed embodiment, this is critical for understanding complex systems. All known or imagined factors, along with their relative influence on one another, must be accounted for because until they are accounted for in the context of the entire system, it is impossible to know what factors might be so uninfluential that they could be treated as irrelevant: not part of the system. 2D models, if comprehensive, become so expansive across two dimensions that they leave users to choose between “zooming in” to view only a few factors (out of what might be dozens, hundreds, or even thousands) at a time, or “zoom out” and be overwhelmed by a “yard sale” of visible factors and lose the ability to even identify, much less explore, smaller clusters of factors, or individual factors. To use a common metaphor, one cannot see “the forest for the trees,” or the trees for the forest for that matter if one is zoomed too far in or out. In 3D, when one has moved in close to a relatively small portion of a model to explore a single node of cluster of nodes, it is likely that the larger model can remain, at least in-part, visible in the background. This creates spatial continuity that keeps a user of the environment constantly aware of the whole model; the “bigger picture.” The use of 3D spatial visualization utilizes one of the most well-developed capacities of the human brain: it's visual system's capacity to optimally learn and memorize information that is spatialized in 3D.

Visualizing the relationships between and among factors, while restrictive in 2D, is also expanded in 3D. Relationships can be articulated with much greater specificity due to the exponential increase of spatial choices for relative placement. And connection symbols can be routed to be much shorter when connecting otherwise distant nodes across a 3D model.

Innovations in media and visualization tools can displace traditional modeling with new capacities more appropriate for meeting with the challenges of our time. Because environments for seeing large and complex systems comprehensively and simultaneously are not yet available as products, the literature on their value for sensemaking is only just beginning to appear, so empirical arguments with large subject pools have not been done to make, or present evidence against, the case. Those currently entrusted with meeting large systemic challenges are inculcated to use far more reductive, linear, alphanumeric, and segmented ways of working with data and information—a nearly opposite practice to what is being proposed in this disclosure—and change is difficult for people. It is believed that those who are exposed to and thus consider shifting toward more comprehensive and simultaneous visualization environments would be deterred should those environments, at first glance, appear to represent information in ways that seem disorganized and chaotic. This is certainly true of models created with traditional systems thinking notation. The advent of 3D concept modeling applications for immersive environments offers a third dimension to visually articulate inter-factor relationships, but they facilitate only freeform visual modeling, which tends to lead to models that also seem like a spatial morass that is difficult to comprehend and perceived as information overload. This condemns users to a slow, painstaking, manual process of articulating such relationships which is very cumbersome for the large models of complex systems. While efforts to ameliorate the problem can be found in 2D modeling for systems engineering, the present disclosure is an effort to do so in 3D that the authors have been able to identify. It is expected that this can avoid would-be users' first impression of comprehensive models of complex system being frustration and befuddlement. It utilizes an automated feature referred to as organizing armatures (underlying structural system), the first one of which has been engineered as a taxonomic structure analogous to a textual outline but without the linearity that is the nature of textual structure. Users identify the main subject of the system they want to model and that becomes a central node. Contributing to that are upstream primary, secondary, tertiary . . . etc. factors that appear in an ever-widening lattice of recursive factors that conform to a hemispherical, bowl-like schema (see e.g., FIG. 3) so that when one moves to the center of the structure, within virtual, immersive space, all the levels of contributing factors do not occlude one another as they would if the structure conformed to a flat, circular plane. Primary factors can be stacked vertically, each with its own hemispherical bowl of progressively upstream contributing factors—also shown in FIG. 3. Further, the various levels of factors can be systematically and recursively hidden or revealed (main subject, primary factors, secondary factors, etc.) in synchronization with the developing comprehension of those seeing a model for the first time. Successful communication of a large and complex system, therefore, is envisioned as the product of a model appearing organized. This is something expected of all information structured for communication, from books to data visualizations. The automated armature feature facilitates rapid production of organized models. Such structures not only organize the appearance of data and information, but its actual use. The structure encourages modelers to organize their thinking in terms of levels of factorial influence, but also structures the embedded computational capacity engineered into the disclosed embodiment. Both features are described in more detail herein.

Systems and computer-implemented methods disclosed herein can be optimized for use with VR/AR (XR) headsets or other stereoscopic, immersive displays which yields benefits in perception, sense-making, attention, and affective experience. Stereoscopic vision and head-tracked parallax shifts (perspective shifts), produce more accurate user perception of comparative distances and sizes of forms and spaces than is the case with 2D graphic tools. Further, research has determined that XR systems' capture and hold user attention by isolating and focusing users' visual perception (VR), not only because headsets might restrict users' vision to the virtual space, but also because of the vibrant and hyperreal aesthetic experience offered by XR technologies.

Exploring large, complex visuospatial models can be a fluid, quick, and easy process to preserve a sense of flow during modeling and analysis. Fortunately, novel mobility tools included in the disclosed environment allow users to navigating the structure of large-scale 3D models in virtual space, much in the way a hummingbird navigates a garden, quickly and effortlessly moving to and from areas of interest. This method of getting around a model may be preferable to rotating and moving the model itself because it maintains spatial continuity with the broader environment around the model, which, if also rotated, can lead to motion sickness in immersive reality applications. As described herein, the present disclosure can allow the inclusion a nearly unlimited number of elements in the same environment, including panoramic photography, 3D objects, and data visualizations of all types. Users of the environment can utilize these elements as landmarks for learning the space and the model in the same way one might use mountains, tall buildings, or celestial bodies for navigation in real space if elements are kept as stationary as possible. As complexity increases for the model and the environment, so does the importance of this feature.

The structural improvements in systems modeling and exploration that immersive 3D supports are possible because of advances in computer graphic capacity and in software design and engineering developed initially to serve the computer gaming industry and which now serve nearly all computing enterprises. It is now possible to render (display) hundreds of millions if not billions of polygons (the basic building block of 3D virtual geometry) and interact with them in real time at frame rates above 90 frames per second (a measure of the speed of rendering). This is a crucial threshold that keeps people from experiencing motion sickness in immersive XR environments, on an average desktop computer equipped for gaming. This provides not only for the expansive and comprehensive 3D modeling described above but also a level of informational detail to describe intricacy far beyond what was previously possible. This is well-recognized as being critical in information and data visualization. Along with the ability to “zoom out” and get a comprehensive view of things. “Overview, always; detail on demand” has become known as Shneiderman's Mantra” after the pioneering researcher of human computer interaction (HCl) Ben Shneiderman.

To feature such capacities, the disclosed embodiment offers users the ability to instantly see and explore visualizations of quantitative and qualitative data. Quantitative data can be visualized in 3D map-charts, if it is georeferenced, or in 3D scatterplots. Qualitative data in the forms of text, images, video, audio, and virtual 3D objects and environments can also be visualized. The graphic capacity of the environment is such that at least 8 high-definition videos can be played simultaneously in the space without lowering the frame rate below 90 frames per second. In numbers limited only by the availability of computation power in a given configuration of the embodiment, these data visualization assets can be configured, saved, and recalled in the environment. To make the exploration of data relevant to a model a fluid process of interaction that preserves the flow of modeling and analysis, data visualization assets can be associated with specific nodes in the model as appropriate to support the input factors the nodes represent within a system model. Once associated, a user can interact with nodes and instantly transport to the visualizations and back.

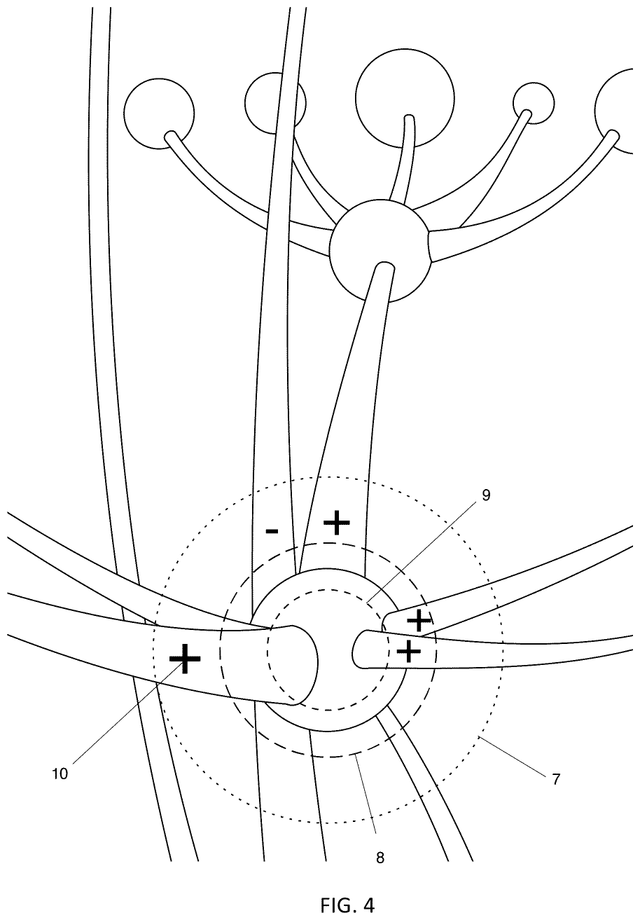

The graphic capacity of the present disclosure also supports the use of more complex symbols for describing the specific influences factors have upon one another through special connection forms (see e.g., FIG. 4) designed to model and quickly communicate the direction of influence between any two factors (nodes), the relative weight of the influencing (upstream) factor upon the influenced (downstream) factor in relation to other input factors, and whether that influence is positive or negative. It is noted that the former reduces the magnitude of the downstream factor; the latter increases it. The practically limitless array of graphic phenomena available in graphic environments developed for gaming, static and animated, can be used in the embodied modeling environment to describe, differentiate, and associate factors and their relationships using form, color, pattern, and movement. Features that leverage these capacities have been, and can continually be, developed to serve systems modeling in the disclosed embodiment and in future iterative embodiments.

Though some digital tools for visualizing systems in 2D offer advanced integrated computational capacities, but the vast majority do not. Much like tools for data visualization that allow the use of 2D “dashboards” for charts, the ones that do provide enough capacity to see factors at once, but nothing like a comprehensive model and view of an entire complex system. Such computation, therefore, cannot calculate a system as a unified whole, even if it can do it in pieces. As noted herein, real systems function as a unified whole and the most vexing challenges are emergent properties of most or all of a system. Without a model that is comprehensive both visually and computationally, the nature of the system and the properties that emerge from it are distorted in fundamental ways (though there are likely be at least some discreet dynamics that happen between only two, or among smaller collections of factors).

A limit of computational or mathematical modeling tools is that they are overwhelmingly designed only for quantitative data, or qualitative data that has been quantified through analysis. This limitation is also a significantly distortive one. Example challenges often involve the beliefs, attitudes, and behaviors of human beings. Because empirical quantitative data has proven extremely valuable in the past it is the form that evidence tends to take in the hard sciences and engineering, and because qualitative can be much more expensive and time consuming to collect and analyze when compared to the amount of sensor and other data created by digital media channels and devices. Therefore, domains of analysis such as public policy marginalize the use of qualitative data. Because many of the factors that might determine, say, human behaviors that affect public health are unwieldy, expensive to collect, ambiguous, or seemingly ephemeral, they are not included. Instead, it is common for quantitative data alone, even if relatively unreliable, to be considered, for the purpose of analysis, a de facto proxy for reality itself, despite that factors omitted because they are supportable only with qualitative data are often as influential as quantitatively supported factors and can prove just as determinant in the outcomes of complex systemic challenges. The exclusion of all data but the quantitative not only prevents models from being comprehensive but distorts the modeling that remains, limiting the types of factors that can be included when modeling systemic challenges in the human sphere. As a result, those responsible for effecting better outcomes for such challenges are increasingly calling for a mixed methods approach.

An even more controversial practice among strategists and decisionmakers' is their use of experience-based human intuition to understand complex systems and decide upon strategies that will be used to meet challenges or seize opportunities that emerge from them. However, leaders in areas such as business or the military might often or even normally include factors that are hunches, “gut-feelings,” or even assumptions in the strategies they develop. Accounting for such thinking as factors in a model, though novel in computational modeling, is part of the tradition of modeling through systems thinking notation and is known as soft systems methodology. Research both acknowledges and supports this practice, but it is not generally captured in computational models of complex systems. In addition to being able to include intuited factors, fully realized comprehensive models facilitate the intuitive spotting and exploration of novel influence connections between and among otherwise disparate factors.

The computational capacity of the embodied disclosure accommodates quantitative data, qualitative data, and intuitive factors. While it will mathematically compute magnitudes and weights for factors supported with quantitative data, it offers users the opportunity to include non-quantitatively supported factors in the visualization of models when users are willing to supply estimations of both the magnitudes of non-quantitative factors and the ways in which they influence other factors, including direction, negative or positive force, and the relative weights of the influence. This computational design is visualized by the design of the models that utilizes nodes, connection forms, and other symbols to communicate factors and their relationships to one another.

As noted in the forementioned material the magnitudes and weights of nodes and edges that form models may be derived in a number of ways. Here and in subsequent points is a description of one such method: Structural Equation Modeling (SEM) performed on a connected server, has the capacity to compute both factor magnitudes and the relative weights of upstream input factors into a downstream factor. Below is a textual description of SEM as it applies to the embodied disclosure.

SEM is a powerful statistical technique that can allow users of the present disclosure to test and visualize complex relationships among multiple variables simultaneously. In the derived network of connections, nodes can represent the variables while directed weighted links will represent the relationships. SEM is particularly well-suited to represent complex systems because it can estimate several interrelated dependence relationships simultaneously, incorporate latent variables, disentangle the direct and indirect pathways through which variables influence one another, and even model non-recursive relationships, including feedback loops where two variables mutually influence each other.

At its core, SEM combines elements of factor analysis and multiple regression. It allows researchers to work with both observed variables, which are directly measured (like “income” or “age”), and latent variables, which are theoretical constructs that cannot be directly measured but are inferred from observed variables (like “intelligence” or “well-being”).

An example formulation of SEM is as follows:

$$Γ {y}_{i} = {Bx}_{i} + {u}_{i} ,$$

where xᵢ represents the ith observations of exogenous variables (independent variables whose values are determined by factors outside the model), yᵢ the observations of endogenous variables (variables that are predicted or explained by other variables within the model), and uᵢ the structural disturbances or unexplained variability. Their relationships are quantified with the structural coefficients Γ and B. The term Γ represents the relationships between endogenous variables and can be lower-triangular for recursive systems (without feedback loops) or of other form (allowing reciprocal causation or feedback loops). The formulation can be extended to include unobservable variables on both sides of the equation (endogenous and exogenous variables). SEM's ability to infer causality is entirely dependent on the validity of the underlying model and structure of the relationships specified by the researcher.

The terms Γ and B may be used to define connections (presence/absence and weights) between nodes (the variables y's and x's). For visualization and interpretation purposes, the coefficients (connections) can be rescaled to match the node diameters. By following different possible paths in the resulting network, various direct and indirect influences among the variables can be highlighted or quantified.

The computational component of SEM may include techniques that are more advanced and flexible than the traditional multiple linear regression. It can incorporate more complex nonlinear associations (for example, using generalized linear or generalized additive models—statistical models that can handle non-normal data and non-linear forms of relationships between variables) and machine learning techniques such as regression trees and artificial neural networks. In particular, machine learning techniques can be used: a) to search for patterns and potential relationships in large disparate datasets or b) to replace the statistical models in SEM.

For the purposes of modeling complex systems as disclosed here, SEM improves upon traditional multiple regression because it can be used to explore causal relationships and build a more comprehensive model where influences among variables can follow multiple paths. Compared to other observational causal methods like propensity score matching and instrumental variable analysis, SEM tests a broader system of causal relationships rather than the causal effect of a single treatment or exposure. SEM allows movement beyond simple cause-and-effect statements and instead build a comprehensive “network” of how multiple factors interact, both directly and indirectly, to shape a particular phenomenon.

The flexibility of SEM has led to its adoption in a wide array of disciplines, including psychology, sociology, education, marketing, ecology, and genetics. Essentially, any field that deals with complex, multivariate systems can benefit from the application of SEM.

FIG. 3 illustrates a diagram of a 3D representation of a system in accordance with embodiments of the present disclosure. Referring to FIG. 3, reference 1 is a root node of a model, representing the subject of the model, or the ultimate outcome, phenomenon, or effect being modeled, and where the size of the node represents the magnitude of the factor compared to what it could be and normally is. Reference 2 shows connection between nodes, which represent factors in the subject, which indicate the direction of influence and the weight of one influence relative to the others flowing from an upstream to a downstream node. Reference 3 is a primary node, reference 4 is a secondary node, and reference 5 is a tertiary node. Reference 6 is an example of a connection that creates a feedback loop.

FIG. 4 illustrates a diagram of another 3D representation of a system in accordance with embodiments of the present disclosure. Referring to FIG. 4, reference 7 shows historical, empirical, or estimated maximum magnitude of a factor. Reference 8 shows historical, empirical, or estimated maximum median of a factor. Reference 9 shows historical, empirical, or estimated maximum median of a factor. Reference 10 is a label indicating whether the influence represented by the connection is positive or negative.

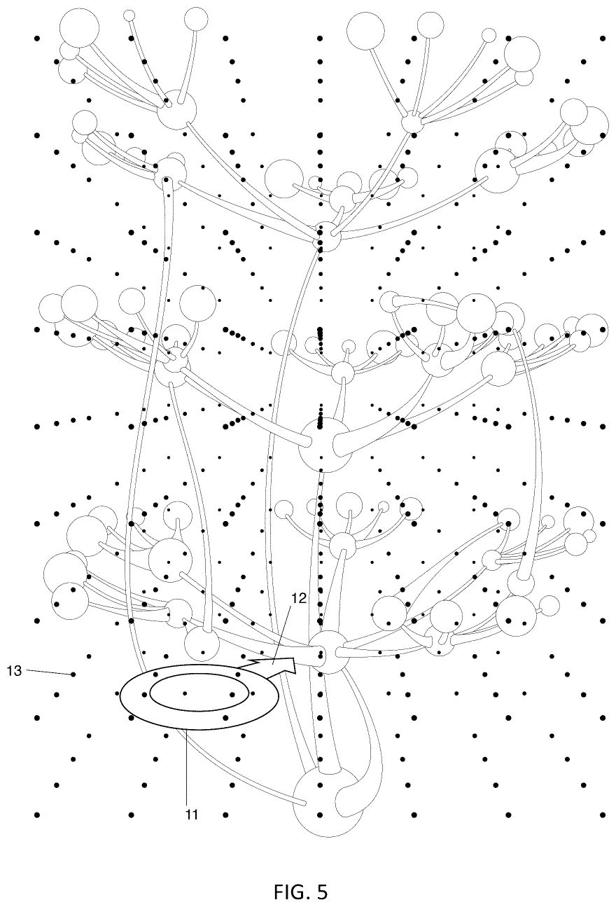

FIG. 5 illustrates a diagram of another 3D representation of a system in accordance with embodiments of the present disclosure. Referring to FIG. 5, reference 11 is a waypoint location, representing where a user is located within the 3D environment. Reference 12 is an arrow indicating the direction the user is facing when located at the waypoint. Reference 13 is a 3D matrix of points to which a user can teleport using a teleport function.

In embodiments disclosed herein, systems and computer-implemented methods can provide a visual environment to integrate conceptual or systems models with the data that support them in a single, unified, immersive 3D environment. These allow people to see and analyze data while building a visual knowledge model of what they are learning—adjusting it as they go—and use it as a decision support system. The hypothesis driving the development of this invention is that such an environment will significantly improve our ability to meet the challenges that arise from CAS (complex adaptive systems) for several reasons. First, the integration that is the innovation of the described invention allows analysts and strategists to avoid shifting from one visualization environment to another as they explore datasets and build conceptual and also computational knowledge models based on them. Changing visualization environments at the rate needed to explore the multifactorial reality of CAS challenges while making sense of what is learned through systems modeling will not only lead to the accumulation of significant wasted time, it will also interrupt the flow of thinking, reducing the depth of focus analysts and strategists require to deal with CAS challenges. Second, the connections between the knowledge model and the data that support it cannot be either concretely specified or visualized across the existing, separate visualization software tools needed for data visualization and systems modeling. Such connections are not only as fundamental to the veracity of a knowledge model as reference citations are to research publications, they are also the source of the insights that fuel innovation in problem-solving, particularly when such connections occur between what had previously been considered disparate and unconnected data points. If connected to an evolving systems model, and noted as connections of interest, such improbable connections are the stuff of epiphany—the so-called “aha” moments coveted and aspired to as the apex of synthetic and creative thinking.

It is important to note that the use of virtual 3D space, via the software and hardware that make it possible, offers several advantages that support the function of the invention. Three dimensions offer an exponential increase in cartesian space and thus allow for the visual display of a much larger number of distinct datasets than is true of the 2D counterpart. Because the inventors have accommodated both quantitative and qualitative in any of their forms, CAS analysts and strategists can use the invention to account for all known, or imagined factors, that influence a CAS challenge and see a higher number of them simultaneously than ever before. While at first, the specific relationships among factors in a vast landscape of disparate factors might be entirely ambiguous, the experience of seeing them in juxtaposition foments important high-order thinking processes needed to meet the challenges that emerge from CAS.

The conceptual modeling features of the present disclosure utilize a 3D version of the familiar 2D bubble and line diagrams used to organize thoughts in systems thinking notation methods. They replace the 2D bubbles to which people are accustomed, with 3D geometric spheres that represent the central issue or subject being studied and the influencing factors and subfactors. Non-spherical geometric forms, such as cubes or tetrahedrons, connect directly to quantitative or qualitative data sources and specific data points. The present disclosure provides users with labeling and coloring tools for the model to denote categories of data and factors. The spheres are connected by lines with arrows like traditional conceptual diagrams and the notation used for systems thinking. The connecting lines can illustrate feedback loops and can curve to accommodate one another over circuitous spans.

While applied in some instances to immersive virtual reality (VR), the present disclosure can also be useful when accessed on flat computer monitors. The key benefits of VR, however, support the utility of the present disclosure by leveraging advances in graphic computing and display technologies to facilitate spatial perception. VR equipment (headsets display systems linked to computing hardware) typically includes a stereo vision display and head position tracking capability. Stereo vision, where each of a person's two eyes sees a scene from a slightly different perspective, allows the brain's visual system to use triangulation to aid spatial perception—the ability to understand the relationships among objects and environments in space—when compared to the monoscopic view that is most common to the use flat computer monitoring screens (though flat, non-headset displays can be configured to facilitate stereoscopic vision using additional equipment and special eyeglasses for the user). Head tracking which includes both the position of the center of a user's head in 3D space and the angle of the head, allows a user to perceive parallax shifts (changes in the spatial relationships among objects and phenomena that are spatialized in 3D) as their head moves. The brain's visual system resolves such changes by developing an understanding of where objects must be situated in space to explain the changes by head movement alone and not the movement of the actual objects in space. Stereoscopic vision, combined with the perception of parallax shift allows users' brains to build their own virtual, internal models of a spatial environment much more readily and accurately than without them. Because the human brain, due to evolutionary expedience, excels at perceiving, interpreting, and comprehending 3D space, and also remembering what is in it, facilitating spatial perception can, thus, powerfully aid in cognition. Given the complexity of meeting challenges that emerge from CAS, optimizing cognition using all available resources is a high-value goal. At a time when many of the most vexing challenges facing society appear to be emergent properties of the interplay among CAS, even modest improvements in the disclosed tools to meet those challenges are particularly valuable.

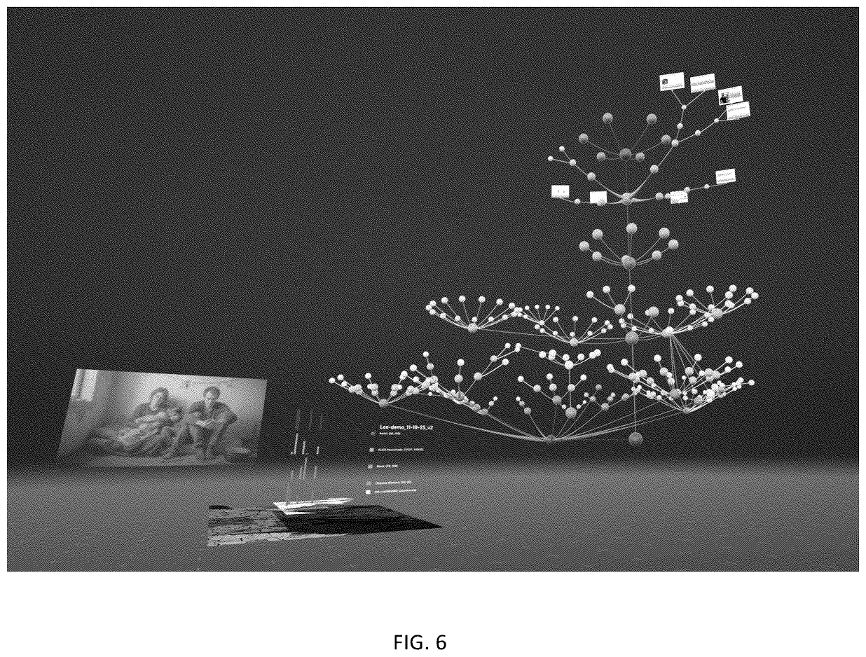

FIG. 6 shows a screen display of an immersive 3D environment for integrating data into systems modeling in accordance with embodiments of the present disclosure. Referring to FIG. 7, this figure shows a geo-referenced, and qualitative data components integrated with a modeling tool.

FIG. 7 illustrates a diagram of a constructed example of systems thinking notation. As with the embodiment disclosed, it uses the network structure of nodes and edges but no larger structural idea that can quickly allow viewers to get a sense of the whole. While grouping or “clustering” of nodes, and color are used sometimes in systems thinking notation diagrams, 2D is much more limited than 3D for using spatial position to articulate nuances among inter-nodal relationships for reasons mentioned elsewhere in this disclosure. Consequently, it remains difficult in 2D to get a sense of the whole, and of smaller components simultaneously.

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together but may comprise disparate instructions stored in different locations which, when joined logically together, comprise the computing device and achieve the stated purpose of the computing device. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer. A typical mobile computing device is a wireless data access-enabled device (e.g., an iPHONE® smart phone, an iPAD® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth, Near Field Communication, CDPD, CDMA, GSM, PDC, PHS, TDMA, FLEX, ReFLEX, iDEN, TETRA, DECT, DataTAC, Mobitex, EDGE and other 2G, 3G, 4G, 5G, and LTE technologies, and it operates with many handheld device operating systems, such as EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

An executable code of a computing device may be a single instruction, or many instructions, and may even be distributed over several different code segments, among different applications, and across several memory devices. Similarly, operational data may be identified and illustrated herein within the computing device, and may be embodied in any suitable form and organized within any suitable type of data structure. The operational data may be collected as a single data set, or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

As referred to herein, a computer network may be any group of computing systems, devices, or equipment that are linked together. Examples include, but are not limited to, local area networks (LANs) and wide area networks (WANs). A network may be categorized based on its design model, topology, or architecture. In an example, a network may be characterized as having a hierarchical internetworking model, which divides the network into three layers: access layer, distribution layer, and core layer. The access layer focuses on connecting client nodes, such as workstations to the network. The distribution layer manages routing, filtering, and quality-of-server (QoS) policies. The core layer can provide high-speed, highly-redundant forwarding services to move packets between distribution layer devices in different regions of the network. The core layer typically includes multiple routers and switches.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

1. A computer-implemented method for representing data, information, and knowledge graphically on a display, the method comprising:
receiving a dataset comprising data items each associated with a system;
determining at least one attribute of the system;
providing a plurality of visual encodings for a three-dimensional representation of the system, wherein the plurality of visual encodings include nodes and one or more node edges;
mapping at least one of the data items and/or the at least one attribute of the system to one of the nodes and the node edge of the plurality of visual encodings;
rendering, on a display, the three-dimensional representation of the system that includes graphical representations of nodes connected by the one or more node edges that are mapped by the at least one of the data items and/or the at least one attribute of the system;
receiving, via a user interface, user interaction with the rendered three-dimensional representation of the system; and
in response to the user interaction, updating the at least one of mappings and/or the graphical representations to generate an updated three-dimensional representation of the system.

2. The computer-implemented method of claim 1, further comprising:
receiving, via the user interface, a selection that identifies a subset of the rendered three-dimensional representation of the system; and
re-rendering the three-dimensional representation of the system based on the identified subset.

3. The computer-implemented method of claim 1, wherein the data items include categories and/or relationships among others of the data items.

4. The computer-implemented method of claim 1, wherein graphical representations of nodes are spheres, and graphical representations of node edges are linear shapes.

5. The computer-implemented method of claim 1, wherein rendering the three-dimensional representation of the system includes rendering the three-dimensional representation of the system to spatially organize nodes by categories of data items in the dataset.

6. The computer-implemented method of claim 1, further comprising:
receiving, via the user interface, a selection that identifies a subset of the rendered three-dimensional representation of the system;
re-rendering the data three-dimensional representation of the system based on the identified subset; and
controlling the display to present a fluid navigation to the re-rendered three-dimensional representation of the system.

7. The computer-implemented method of claim 1, further comprising presenting, via the display, one or more annotations to the three-dimensional representation of the system.

8. The computer-implemented method of claim 7, wherein the annotations include text and/or one or more images.

9. The computer-implemented method of claim 1, further comprising:
applying generative artificial intelligence (AI) technology to the dataset of the system to generate another dataset for improving human analysis of the dataset of the system; and
re-rendering the three-dimensional representation of the system based on the generated other dataset.

10. The computer-implemented method of claim 1, further comprising presenting, via the display, one or more navigational marks including a mark that orients a viewer with respect to the rendered three-dimensional representation of the system, and/or a mark that is interactive for re-rendering the three-dimensional representation of the system.

11. The computer-implemented method of claim 1, wherein the display includes a standard display, a virtual reality (VR) display, and an augmented reality (AR) display.

12. The computer-implemented method of claim 1, further comprising determining a user input action and/or a computer-generated estimate, and
wherein at least one attribute comprises the determined user input action and/or a computer-generated estimate.

13. The computer-implemented method of claim 1, wherein types of the data items include raw qualitative data,
wherein the computer-implemented method further comprises:
associating, by user input into the user interface, the raw qualitative data with one of the nodes; and
representing a user-estimated magnitude value with a size of an associated node, and/or a weight of influence with a connector that indicates an influence of an upstream node on a downstream node.

14. The computer-implemented method of claim 1, wherein magnitudes are assigned to nodes;
wherein weights are assigned to node connectors;
wherein the computer-implemented method further comprises:
determining a change to one or more of the magnitudes, and/or a change to one or more of the weights; and
re-rendering the three-dimensional representation of the system based on the determined change to the one or more of the magnitudes, and/or the change to one or more of the weights.

15. The computer-implemented method of claim 14, further comprising:
receiving, via the user interface, user-input for changing the one or more of the magnitudes, and/or for changing the one or more of the weights; and
wherein the three-dimensional representation of the system is re-rendered based on the user-input.

16. The computer-implemented method of claim 14, wherein a plurality of the nodes and node edges are re-rendered based on the user-input for changing the one or more of the magnitudes, and/or for changing the one or more of the weights.

17. The computer-implemented method of claim 1, wherein the user interface is a first user interface operated by a first user, and wherein the display is a first display;
wherein the computer-implemented method further comprises:
providing a second user interface operated by a second user;
providing a second display for display to the second user;
rendering, on the second display, the three-dimensional representation of the system;
receiving, via the second user interface by the second user, user interaction with the rendered three-dimensional representation of the system via the second display; and
in response to the user interaction by the second user, updating the at least one of mappings and/or the graphical representations to generate an updated three-dimensional representation of the system for display on the first display and the second display.

18. A system for representing data graphically on a display, the system comprising:
a user interface;
a display; and
a system visualization manager comprising at least one processor and memory configured to:
receive a dataset comprising data items each associated with a system;
determine at least one attribute of the system;
provide a plurality of visual encodings for a three-dimensional representation of the system, wherein the plurality of visual encodings include nodes and one or more node edges;
map at least one of the data items and/or the at least one attribute of the system to one of the nodes and the node edges of the plurality of visual encodings;
control the display to render the three-dimensional representation of the system that includes graphical representations of nodes connected by the one or more node edges that are mapped by the at least one of the data items and/or the at least one attribute of the system;
receive, via the user interface, user interaction with the rendered three-dimensional representation of the system; and
update the at least one of mappings and/or the graphical representations to generate an updated three-dimensional representation of the system in response to the user interaction.

19. The system of claim 18, wherein the system visualization manager is configured to:
receive, via the user interface, a selection that identifies a subset of the rendered three-dimensional representation of the system; and
re-render the three-dimensional representation of the system based on the identified subset.

20. The system of claim 18, wherein the data items include categories and/or relationships among others of the data items.

21. The system of claim 18, wherein graphical representations of nodes are spheres, and graphical representations of node edges are linear shapes.

22. The system of claim 18, wherein the system visualization manager is configured to render the three-dimensional representation of the system to spatially organize nodes by categories of data items in the dataset.

23. The system of claim 18, wherein the system visualization manager is configured to:
receive, via the user interface, a selection that identifies a subset of the rendered three-dimensional representation of the system;
re-render the data three-dimensional representation of the system based on the identified subset; and
control the display to present a fluid navigation to the re-rendered three-dimensional representation of the system.

24. The system of claim 18, wherein the display is configured to present one or more annotations to the three-dimensional representation of the system.

25. The system of claim 24, wherein the annotations include text and/or one or more images.

26. The system of claim 18, wherein the system visualization manager is configured to:
apply generative artificial intelligence (AI) technology to the dataset of the system to generate another dataset for improving human analysis of the dataset of the system; and
re-render the three-dimensional representation of the system based on the generated other dataset.

27. The system of claim 18, wherein the display is configured to present one or more navigational marks including a mark that orients a viewer with respect to the rendered three-dimensional representation of the system, and/or a mark that is interactive for re-rendering the three-dimensional representation of the system.

28. The system of claim 18, wherein the display includes a standard display, a virtual reality (VR) display, and an augmented reality (AR) display.

29. The system of claim 18, wherein the system visualization manager is configured to determine a user input action and/or a computer-generated estimate, and
wherein at least one attribute comprises the determined user input action and/or a computer-generated estimate.

30. The system of claim 18, wherein types of the data items include raw qualitative data, wherein the system visualization manager is configured to:
associate, by user input into the user interface, the raw qualitative data with one of the nodes; and
represent a user-estimated magnitude value with a size of an associated node, and/or a weight of influence with a connector that indicates an influence of an upstream node on a downstream node.

31. The system of claim 18, wherein magnitudes are assigned to nodes;
wherein weights are assigned to node connectors;
wherein the system visualization manager is configured to:
determine a change to one or more of the magnitudes, and/or a change to one or more of the weights; and
re-render the three-dimensional representation of the system based on the determined change to the one or more of the magnitudes, and/or the change to one or more of the weights.

32. The system of claim 31, wherein the system visualization manager is configured to:
receive, via the user interface, user-input for changing the one or more of the magnitudes, and/or for changing the one or more of the weights; and
wherein the three-dimensional representation of the system is re-rendered based on the user-input.

33. The system of claim 31, wherein the system visualization manager is configured to re-render a plurality of the nodes and node edges based on the user-input for changing the one or more of the magnitudes, and/or for changing the one or more of the weights.

34. The system of claim 18, wherein the user interface is a first user interface operated by a first user, and wherein the display is a first display;
wherein the system visualization manager is configured to:
provide a second user interface operated by a second user;
provide a second display for display to the second user;
render, on the second display, the three-dimensional representation of the system;
receive, via the second user interface by the second user, user interaction with the rendered three-dimensional representation of the system via the second display; and
update the at least one of mappings and/or the graphical representations to generate an updated three-dimensional representation of the system for display on the first display and the second display in response to the user interaction by the second user.
